(19) United States
(12) Patent Application Publication
(10) Pub. No.: US 2019/0124850 A1
(43) Pub. Date: May 2, 2019

(54) CROPS MANAGEMENT SYSTEM

(71) Applicant: KUBOTA CORPORATION, Osaka (JP)

(72) Inventors: Seiichi OKAMURA, Osaka (JP); Kanta TAKECHI, Osaka (JP); Daisuke NAITO, Osaka (JP)

(73) Assignee: KUBOTA CORPORATION, Osaka (JP)

(21) Appl. No.: 16/231,780

(22) Filed: Dec. 24, 2018

Related U.S. Application Data
(63) Continuation of application No. PCT/JP2017/036725, filed on Oct. 11, 2017.

(30) Foreign Application Priority Data
Oct. 12, 2016 (JP) 2016-201264

(51) Int. Cl. A01F 15/08; A01F 15/07; G06K 19/07

(52) U.S. Cl. CPC A01F 15/0825; A01F 15/071; A01F 2015/0891; G06K 19/0723; A01F 2015/076; A01F 15/0883

(57) ABSTRACT

A crops management system includes an information outputting device disposed on a forming machine configured to form crops into a formed material having a predetermined shape and configured to output formed material information relating to the formed material, a wireless tag disposed on the formed material and configured to store identifying information of the formed material, and a management device having an obtaining part configured to obtain the identifying information of the formed material and the formed material information of the formed material, and a relating part configured to relate the formed material information to the identifying information obtained by the obtaining part.

### CROSS-REFERENCE TO RELATED APPLICATIONS

The present application is a continuation application of International Application No. PCT/JP 2017/036725, filed Oct. 11, 2017, which claims priority to Japanese Patent Application No. 2016/201264, filed Oct. 12, 2016. The content of this application is incorporated herein by reference in their entirety.

### BACKGROUND OF THE INVENTION

### Field of the Invention

The present invention relates to a crops management system.

### Description of Related Art

Conventionally, agricultural work has been carried out in which, after the farm pasture or the like is taken in a roll baler or the like, the grass is formed into a roll by the roll baler and discharged again to the farm (for example, Microfilm of Japanese Utility Model Application Publication No. S61-145956).

The roll bale discharged from the roll baler is generally stacked in a storage place by a transport vehicle such as a truck.

### SUMMARY OF THE INVENTION

A crops management system includes an information outputting device disposed on a forming machine configured to form crops into a formed material having a predetermined shape and configured to output formed material information relating to the formed material, a wireless tag disposed on the formed material and configured to store indentifying information of the formed material, and a management device having an obtaining part configured to obtain the identifying information of the formed material and the formed material information of the formed material, and a relating part configured to relate the formed material information to the identifying information obtained by the obtaining part.

### DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a view illustrating a crops management system according to a first embodiment of the present invention;

FIG. 2 is a whole view illustrating a roll baler according to the first embodiment;

FIG. 3 is a view illustrating a state where the roll baler travels in an agricultural field to form a formed material according to the first embodiment;

FIG. 4A is a view illustrating a tag identifying information, a weight, and a moisture obtained by an obtaining part according to the first embodiment;

FIG. 4B is a view illustrating the weight, the moisture, and the tag identifying information related to each other by a relating part according to the first embodiment;

FIG. 5A is a view illustrating the tag identifying information, the weight, and the moisture obtained by the obtaining part according to the first embodiment;

FIG. 5B is a view illustrating the weight, the moisture, and the tag identifying information related to each other by the relating part according to the first embodiment;

FIG. 6 is a view illustrating a state where a roll-formed material is stored in a storage place; and

FIG. 7 is a view illustrating a crops management system according to a second embodiment of the present invention.

### DESCRIPTION OF THE EMBODIMENTS

The embodiments will now be described with reference to the accompanying drawings, wherein like reference numerals designate corresponding or identical elements throughout the various drawings. The drawings are to be viewed in an orientation in which the reference numerals are viewed correctly.

Hereinafter, embodiments of the present invention will be described with reference to the drawings.

### First Embodiment

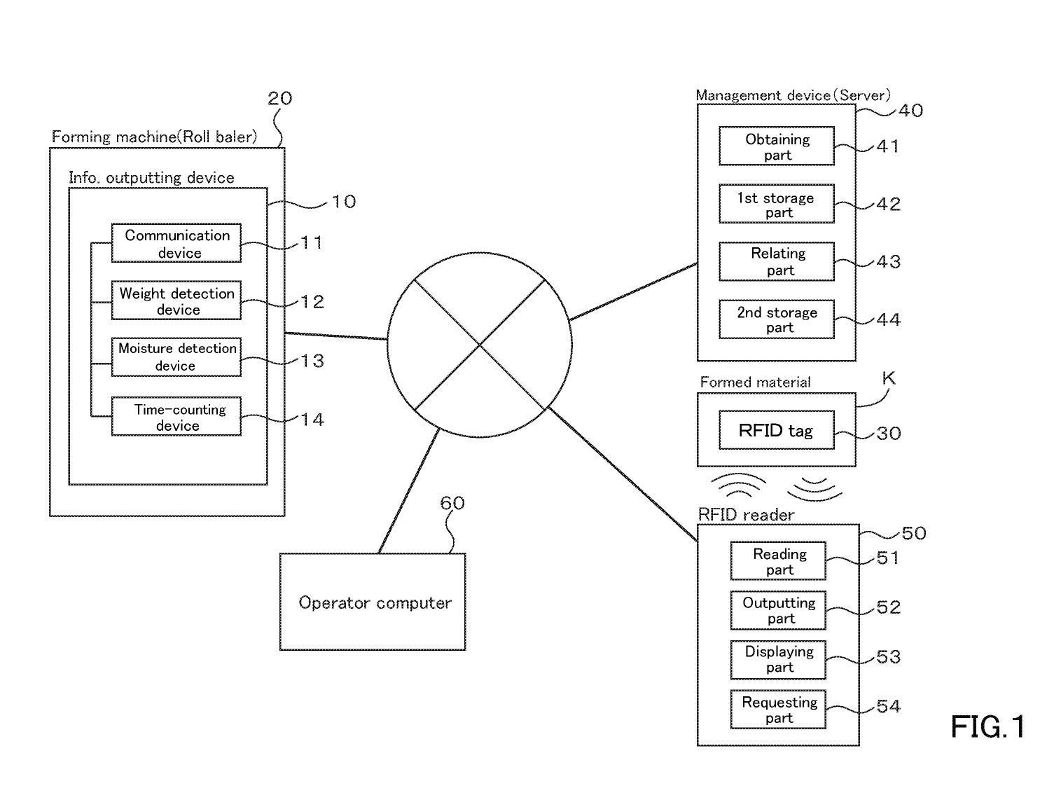

FIG. 1 shows a schematic diagram of a crops management system.

Crops management system is a system that manages crops such as grass, hay, rice and the like. Crops are not limited to those mentioned above.

The crops management system includes an information output device 10 provided in a forming machine. The forming machine 20 is a machine that collects crops such as farms and shapes the collected crops into a predetermined shape in a roll shape or a rectangular shape (a cube shape). The forming machine 20 is, for example, a roll baler for shaping a crop into a roll shape, a hole crop or the like.

First, taking the roll baler as an example, the forming machine 20 will be described.

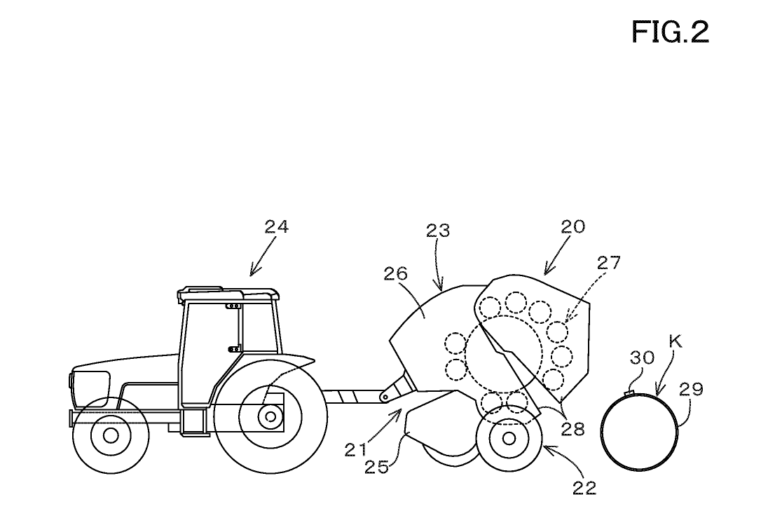

As shown in FIG. 2, the roll baler 20 includes a vehicle body 21, a traveling device 22 provided on the vehicle body 21, and a forming device 23 provided on the vehicle body 21. The traveling device 22 is a wheel type running device 22 having wheels.

The traveling device 22 may be a crawler type traveling device 22 having a crawler belt.

The roll baler 20 may be a self-propelled type that has a prime mover such as an engine or the like, and may be a pulling type pulled by a towing vehicle 24 such as a tractor and the like. In this embodiment, the roll baler 20 is the pulling type connected to a tractor or the like via a connecting portion at a front portion of the vehicle body 21.

The forming device 23 includes an intake part 25 for taking in the crop to be formed into a roll, a housing portion 26 for accommodating the crop taken in by the intake part 25, a forming portion 27 for forming the crops taken into the housing portion 26 into a material K rolled by a roller or the like, and a discharge portion 28 for discharging the forming material K formed by the forming portion 27.

Thus, the crop is formed into a roll-shaped forming material K of a predetermined size by the forming device 23, and is discharged to the outside after forming. For the sake of convenience of explanation, the rolled forming material K may be referred to as a roll formed material.

The forming device 23 is not limited to the above-described configuration, and any apparatus may be used as long as the apparatus forms the crop in a predetermined shape. For example, the forming device 23 may be of a chain type in which crops are formed in a roll shape by a chain, a belt type by which a belt is formed into a roll shape by a belt, or another type.

In addition, the forming device 23 preferably has a mechanism (a winding mechanism) for winding the packing material 29 such as a net on the side surface of the roll forming material K. In this case, the packing material 29 can be discharged to the outside from the discharge portion 28 in a state of being wrapped around the side surface of the roll forming material K.

As shown in FIG. 1, the information output device 10 is a device capable of outputting information (hereinafter referred to as “forming material information”) on the forming material K formed by the forming device 23.

Specifically, the information output device 10 includes a communication device 11, a weight detection device 12, a moisture detection device 13, and a time counting device 14. The weight detection device 12, the moisture detection device 13, and the time counting device 14 are connected to the communication device 11.

The communication device 11 is a device that performs a short range communication or a long range communication in wireless or the like, and is connectable to a device external to the forming machine 20. For example, the communication device 11 is a communication module that performs wireless communication using the Wi-Fi (Wireless Fidelity (a registered trademark) of IEEE 802.11 series which is a communication standard, the Bluetooth (a registered trademark) of IEEE 802.15 series and the like.

It should be noted that the communication device 11 may be a communication module that performs the wireless communication via a cellular phone communication network, a communication module that performs wireless communication via a data communication network, or another communication module.

The weight detection device 12 is a device that detects the weight of the forming material K formed by the forming device 23, that is, the weight of the forming material K when discharged to the outside. The weight detection device 12 is composed of a load cell or the like provided in the forming device 23.

The weight detection device 12 outputs the detected weight to the communication device 11 as the forming material information. It is preferable that the weight detection device 12 adds the management information such as the management number to the output weight and outputs it to the communication device 11 every time the weight is outputted.

The moisture detection device 13 is a device that detects the moisture (the water content) of the forming material K formed by the forming device 23, that is, moisture of the forming material K at the time of discharge to the outside.

The moisture detection device 13 measures the moisture of the forming material K using the dielectric constant of the forming material K or measures the moisture (the moisture content) of the forming material K using the electric resistance of the forming material K or a sensor that measures moisture by irradiating the forming material K with infrared rays or microwaves or the like.

The moisture detection device 13 may be any device as long as it detects moisture.

The moisture detection device 13 outputs the detected moisture to the communication device 11 as forming material information. It is preferable that the moisture detection device 13 adds management information such as a management number to the moisture to be output and outputs it to the communication device 11 every time moisture is outputted.

The time counting device 14 is a device that measures the time during which the forming material K is formed by the forming machine 20. The time counting device 14 is, for example, a timer for measuring time (date, time of Christian calendar year, month, day and the like.). Based on the operation of the forming device 23, the time counting device 14 transmits to the communication device 11 the start time at which the forming of the forming material K is started, the end time at which the forming of the forming material K was completed, the discharge time at which the forming material K was discharged.

In the above-described embodiment, the information output device 10 includes the weight detection device 12, the moisture detection device 13, and the time counting device 14, but any one of the weight detection device 12, the moisture detection device 13, and the time counting device 14 as long as it has the above-mentioned properties. In addition, the information output device 10 may be any device that outputs information on the forming material K in the forming machine 20, and is not limited to only the weight detection device 12, the moisture detection device 13, and the time counting device 14.

The communication device 11 transmits the forming material information (the weight, the moisture, the time) and the control information to the external computer every time the work of the roll baler 20 is finished or every time the roll forming material K is formed by the roll baler 20, or regularly. In the above-described embodiment, the weight detection device 12 and the moisture detection device 13 attach the management information to the measured values (the weight, the moisture).

Alternatively, the communication device 11 may attach the management information every time the measurement value (the weight, the moisture) is acquired. In addition, when the communication device 11 transmits the forming material information and the management information to an external computer, it is preferable to transmit at least the date.

As shown in FIG. 1, the crops management system includes a wireless tag, that is, an RFID tag (Radio Frequency Identification) 30. The RFID tag 30 is provided on the forming material K. The RFID tag 30 is a tag that transmits identifying information of at least the forming material K.

The identifying information is information for specifying, that is, identifying the forming material K. The identifying information may be any information as long as it is information for identifying the forming material K. The identifying information may be a unique number (serial number) individually assigned to each forming material K, or may be other information.

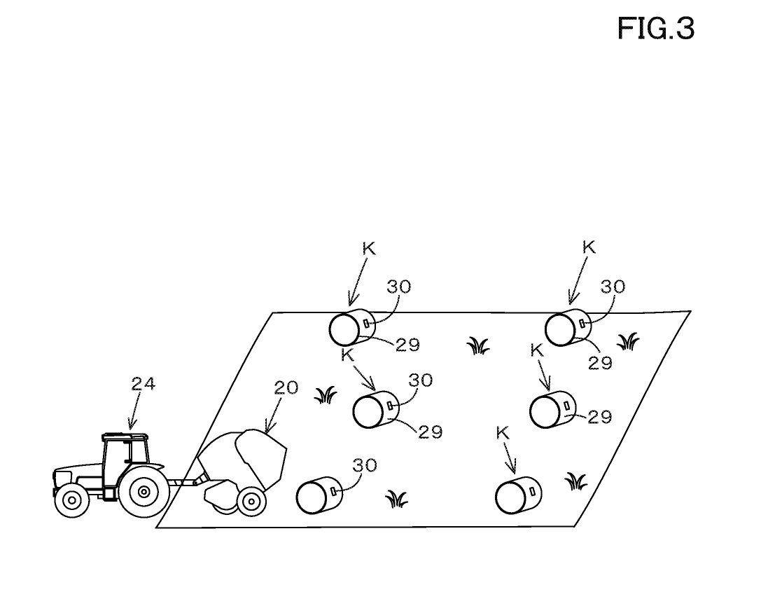

FIG. 3 shows a state in which the forming material K is formed by running the roll baler 20 on a farm or the like. As shown in FIG. 3, in the roll baler 20, since the roll forming material K is discharged to the farm each time the roll forming material K is formed, there are many roll forming materials K discharged from the roll baler 20 on the farm.

An operator or the like prepares the RFID tag 30 in advance and attaches the RFID tag 30 to the roll forming material K discharged to the farm. An operator installs one RFID tag 30 per the roll forming material K. On the farm, the roll forming material K is in a state where the side portion (a side surface) is in contact with the ground of the farm and is sideways.

A packing material 29 such as a net is wrapped around the side of the roll forming material K. For example, the operator attaches the RFID tag 30 to the packing material 29 wrapped around the side of the roll forming material K. As described above, the RFID tag 30 is attached to the packing material 29, but it may be attached to a place other than the packaging material 29 or may be attached to the bottom portion (the bottom surface) of the roll forming material.

As shown in FIG. 1, the crops management system has a management device 40. The management device 40 is a computer such as a server, a mobile terminal, a personal computer, or the like. Note that the portable terminal is a computer that is easy to carry and is a smartphone (a multi-function mobile phone), a tablet, or the like. In this embodiment, the management apparatus 40 is a server.

The server 40 has an obtaining part 41 and a first storage part 42. The obtaining part 41 is composed of a program and the like stored in the server 40, and acquires the identifying information of the RFID tag 30 from the outside. The first storage part 42 is a nonvolatile memory and stores identifying information and the like of the RFID tag 30 acquired by the obtaining part 41.

A method of acquiring the identifying information of the RFID tag 30 by the obtaining part 41 includes a method of reading the identifying information of the RFID tag 30 to the RFID reader 50 and transmitting the read identifying information to the server 40. That is, the crops management system includes the RFID tag 30, that is, the RFID reader 50 (a wireless tag reader) capable of receiving the identifying information of the wireless tag.

The RFID reader 50 is, for example, a portable reader that can be carried by a operator, and has a reading part 51 and an outputting part 52. When the reading part 51 is an antenna or the like and the RFID tag 30 is a passive type RFID tag 30, the reading part 51 irradiates radio waves to the RFID tag 30 and obtains the identifying information of the RFID tag 30 transmitted from the RFID tag 30.

When the RFID tag 30 is the active type RFID tag 30, the reading part 51 requests identifying information from the RFID tag 30 and acquires the identifying information of the RFID tag 30 transmitted from the RFID tag 30 in response to the request.

In the case where the RFID tag 30 is the active type RFID tag 30, the reading part 51 may obtain the identifying information of the RFID tag 30 arbitrarily transmitted from the RFID tag 30 without requesting the identifying information to the RFID tag 30.

The outputting part 52 is a communication device that performs the short-range communication or the long-range communication by radio or the like. When the communication device performs communication over a long distance, the outputting part 52 transmits the identifying information of the RFID tag 30 acquired by the reading part 51 to the server 40.

In addition, in the case of a communication device performing the short-range communication, the outputting part 52 transmits the identifying information of the RFID tag 30 acquired by the reading part 51 to a computer (hereinafter referred to as an operator computer) 60 owned by the operator or the like.

The operator computer 60 receives the identifying information of the RFID tag 30 transmitted from the outputting part 52 of the RFID reader 50, and then transmits the received identifying information to the server 40. The operator computer 60 is, for example, a mobile terminal, a personal computer, or the like.

When transmitting the identifying information of the RFID tag 30 to the server 40 by the RFID reader 50, the information (the user information) on the operator is registered in advance in the RFID reader 50, and together with the user information registered in the RFID reader 50. It is preferable to transmit the identifying information read by the RFID reader 50 to the server 40.

Specifically, the RFID reader 50 has a display part 53. The display part 53 is, for example, a liquid crystal panel monitor or the like, and can display various information. The display part 53 of the RFID reader 50 displays the user registration screen. On the registration screen, user information such as the name, address, phone number, user ID, password, and the like. of the operator can be entered.

The operator registers the user information in the RFID reader 50 by inputting the user information on the registration screen by using an interface or the like provided in the RFID reader 50.

The method of registering the user information in the RFID reader 50 may be another method. For example, displaying a user registration screen on the operator computer 60, registering the user information entered in the user registration screen in the operator computer 60, and transferring the user information registered in the operator computer 60 to the RFID reader 50. The user information may be registered in the RFID reader 50.

By thus transmitting the user information registered in the RFID reader 50 to the server 40 together with the identifying information of the RFID tag 30, the server 40 associates the identifying information of the RFID tag 30 with the user information, and stores them in the first storage part 42.

Note that, before transmitting the identifying information from the RFID reader 50 to the server 40, the RFID reader 50 or the operator computer 60 is connected to the server 40 in advance and the user information is transmitted to the server 40, whereby the user information may be registered the server 40.

In addition, when registering the user information, the server 40 issues a login ID, a password, and the like, and transmits the login ID and password to the RFID reader 50 or the operator computer 60. The RFID reader 50 or the operator computer 60 registers the login ID, password, and the like issued by the server 40.

In this case, after. logging in to the server 40 using the login ID and the password, the operator computer 60 or the RFID reader 50 transmits the identifying information of the RFID tag 30 to the server 40.

The server 40 receives the identifying information and the user information of the RFID tag 30 transmitted from the RFID reader 50 or the operator computer 60 as described above. The obtaining part 41 of the server 40 acquires the identifying information and the user information of the RFID tag 30 when the server 40 receives the identifying information and the user information of the RFID tag 30.

In addition, the obtaining part 41 of the server 40 acquires not only the identifying information of the RFID tag 30 but also the forming material information of the forming material K. The server 40 receives the forming material information (the weight, the moisture, the time) transmitted from the communication device 11. When the server 40 receives the forming material information (the weight, the moisture, the time), the obtaining part 41 acquires the forming material information.

The server 40 has an relating part 43 and a second storage part 44. The relating part 43 is composed of a program and the like stored in the server 40. The second storage part 44 is composed of a nonvolatile memory or the like. Hereinafter, for convenience of description, the identifying information of the RFID tag 30 may be referred to as a “tag identifying information” in some cases.

The relating part 43 associates the tag identifying information acquired by the obtaining part 41 with the forming material information acquired by the obtaining part 41. The association by the relating part 43 will be described.

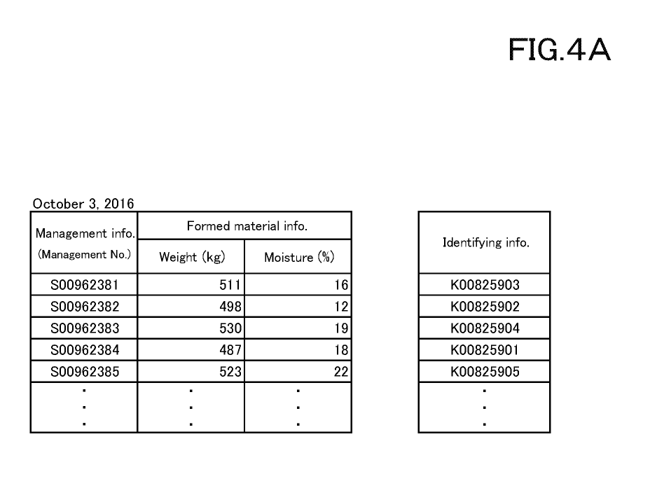

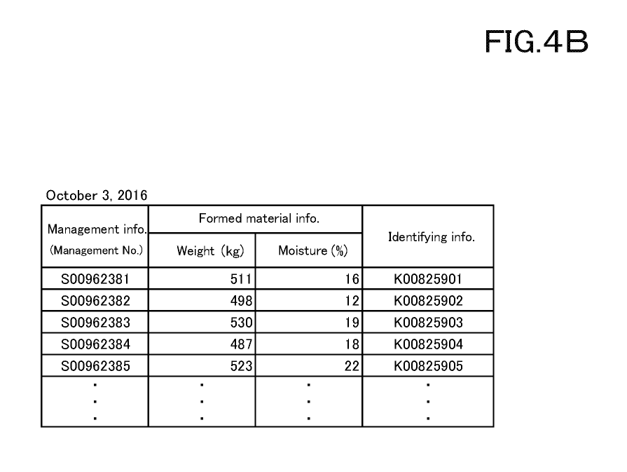

FIG. 4A shows the tag identifying information, the weight and the moisture which are the forming material information acquired by the obtaining part 41 on a predetermined date (for example, Oct. 3, 2016). As shown in FIG. 4A, the forming material information is generated every time the roll forming material K is formed, and the number of the forming material information corresponds to the number of the roll forming material K.

In addition, since one RFID tag 30 is attached to one roll forming material K in the roll forming material K, the number of tag identifying information corresponds to the number of roll forming materials K. Also, the control number shown in FIG. 4A is increased every time the roll forming material K is formed, which means that the larger the number is, the longer the forming time is.

FIG. 4B shows the weight and the moisture of the roll forming material K and the tag identifying information associated with each other by the relating part 43. As shown in FIG. 4B, the relating part 43 refers to the management number corresponding to the predetermined date, and relates the weight and moisture corresponding to the roll forming material K having the smallest management number with the tag identifying information having the smallest number of the plurality of pieces of tag identifying information.

In addition, the relating part 43 associates the weight and moisture corresponding to the roll forming material K having the largest management number with the tag identifying information having the largest number among the plurality of pieces of tag identifying information. That is, the relating part 43 arranges the management number and the tag identifying information sequentially, and associates the weight and moisture corresponding to the management numbers arranged in order with the tag identifying information. The associated forming material information (the weight, the moisture) and the tag identifying information are stored in the second storage part 44 by the associating part 43.

In FIG. 4A, the obtaining part 41 of the server 40 acquires the weight and moisture, but when the obtained forming material information is only the weight, as a matter of course, the relating part 43 associates the weight and the tag identifying information with each other. In addition, when the acquired forming material information is only the moisture, the relating part 43 associates the moisture with the tag identifying information.

When the time (the start time, the end time, the discharge time) is included in the forming material information, the weight and moisture and the tags can be related to each other, using the times (the start time, the end time, the discharge time) instead of the management number.

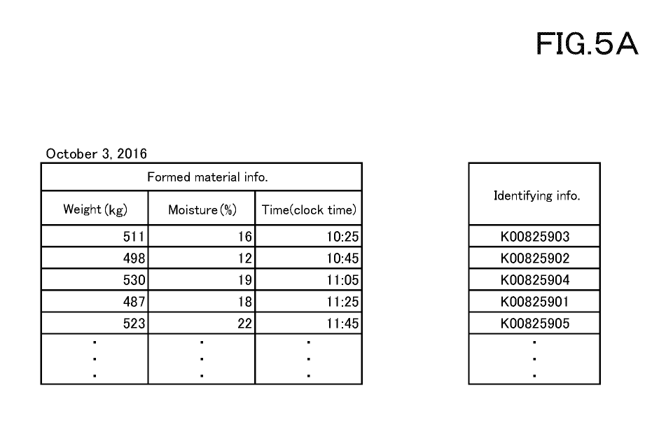

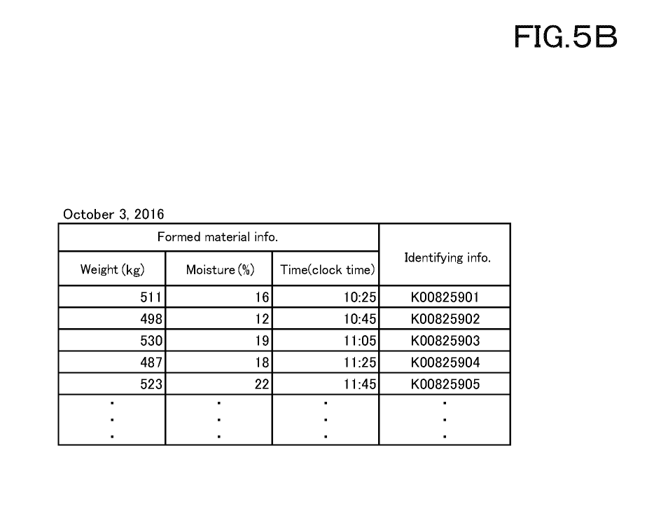

FIG. 5A shows the weight, the moisture, the discharge time, and the tag identifying information acquired by the obtaining part 41 of the roll forming material K at a predetermined date (for example, Oct. 3, 2016). As shown in FIG. 5A, no control number is attached to the forming material information.

FIG. 5B shows the forming material information and tag identifying information associated by the relating part 43. As shown in FIG. 5B, the relating part 43 refers to the discharge time of the roll forming material K at a predetermined date, and associates the weight and the moisture of the latest discharge time in the forming material information with the tag identifying information of the smallest number among the plurality of pieces of tag identifying information.

In addition, the relating part 43 associates the weight and moisture having the latest discharge time in the forming material information with the tag identifying information having the largest number among the plurality of tag identifying information. The relating part 43 may associate the weight and moisture of the roll forming material K with the tag identifying information using the start time, the end time, and the like.

That is, the relating part 43 associates the weight and moisture with the tag identifying information based on the time (the start time, the end time, the discharge time) included in the forming material information. When the forming material information is only time (the start time, the end time, the discharge time), the relating part 43 associates the time with the tag identifying information.

As described above, the crops management system includes the information output device 10 that outputs the forming material information, the RFID tag 30 that stores the identifying information of the forming material K, and the management device 40. Thus, it is possible to grasp the roll forming material K only by reading the tag identifying information provided on the roll forming material K with the RFID reader 50 or the like and outputting it to the management device 40, without describing the information (the date, the agriculture, and the like.) on the roll forming material K by handwriting on the surface of the roll forming material K or the like in order to distinguish the roll forming material K discharged to the farmer by the operator.

For example, when the information output device 10 has the weight detection device 12, the weight of the roll forming material K can be grasped based on the tag identifying information associated with the relating part 43 of the management device 40, as shown in FIG. 4B.

In addition, when the information output device 10 has the moisture detection device 13, it is possible to grasp the moisture of the roll forming material K based on the tag identifying information associated by the associating portion 43 of the management device 40.

When the information output device 10 has the time counting device 14, the time (the forming time, the start time, the end time, the discharge time) can be grasped based on the tag identifying information associated with the relating part 43 of the management device 40.

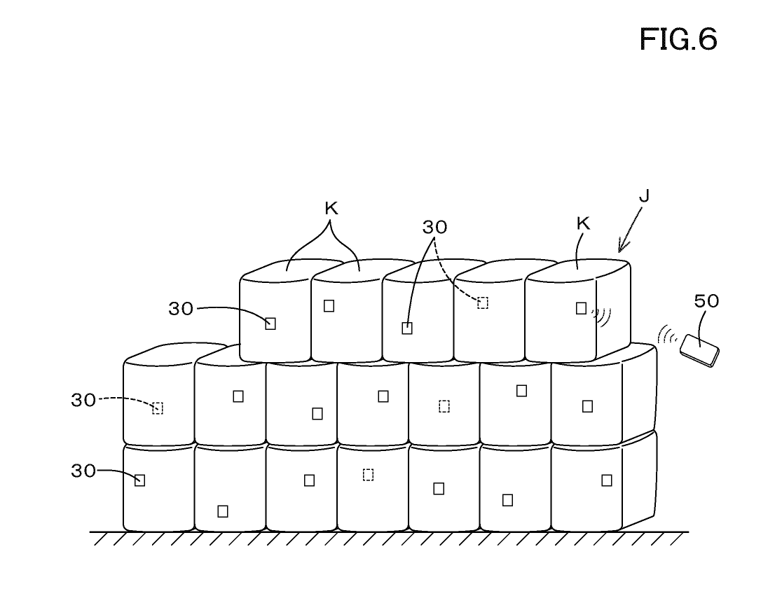

For example, as shown in FIG. 6, the roll forming material K formed by the roll baler 20 is stacked at the storage location J and stored. In many cases, the orientation of the RFID tag 30 in a plurality of roll forming materials K is not constant, and the position of the RFID tag 30 may not be seen from a predetermined position as indicated by a broken line in some cases.

However, by holding the RFID reader 50 over a predetermined roll forming material K stacked in the storage location J, the identifying information of the RFID tag 30 can be read. By transmitting the read identifying information to the server 40, it is possible to grasp the weight, the moisture, the start time, the end time, the discharge time, and the like of the predetermined roll forming material K.

As shown in FIG. 1, the RFID reader 50 preferably has a requesting part 54. The requesting part 54 is composed of a program and the like stored in the RFID reader 50. The requesting part 54 requests the management device 40 for forming material information associated with the tag identifying information read by the reading part 51.

Specifically, the requesting part 54 outputs a request for forming material information together with tag identifying information to the server 40. The server 40 refers to the second storage part 44 based on a request from the requesting part 54 of the RFID reader 50 and extracts the forming material information associated with the tag identifying information corresponding to the request.

In addition, the server 40 transmits the extracted forming material information to the RFID reader 50 which made the request for the forming material information. After receiving the forming material information transmitted from the server 40, the RFID reader 50 displays the forming material information obtained by the request of the requesting part 54 on the display part 53.

In the above-described embodiment, the forming material information is transmitted from the communication device 11 provided in the roll baler 20 directly to the server 40. However, after transmitting the forming material information to the operator computer 60, the forming material information may be transmitted from the operator computer 60 to the server 40.

### Second Embodiment

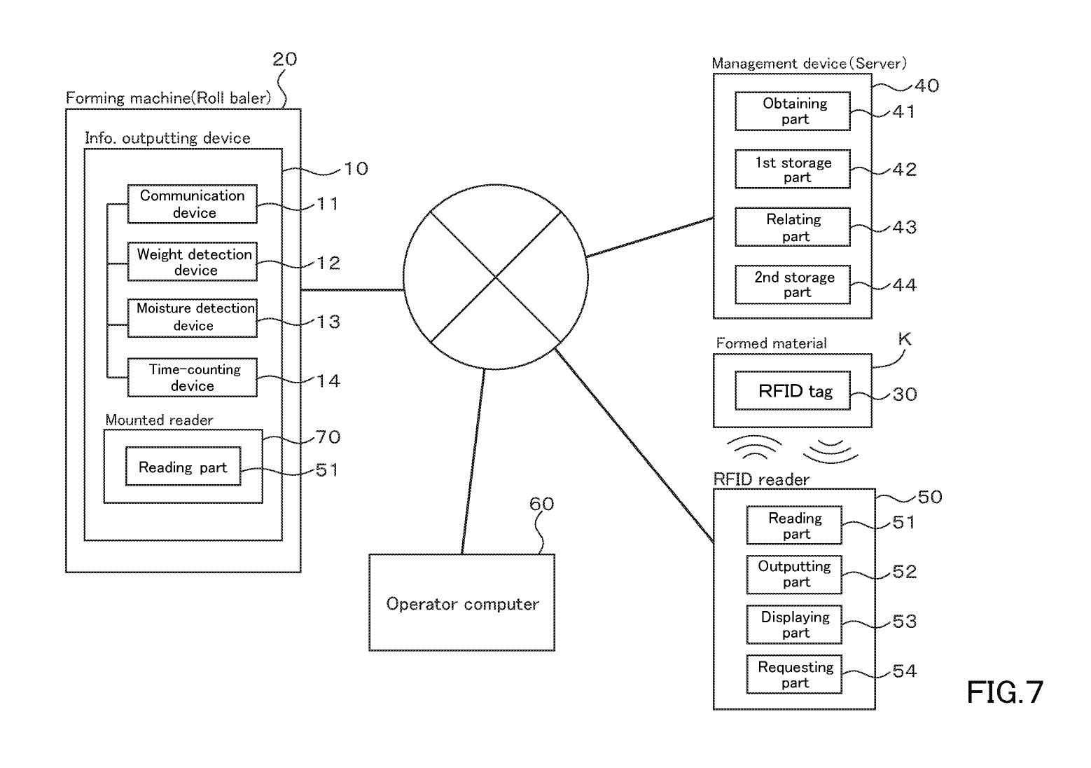

FIG. 7 shows the crops management system according to the second embodiment. The second embodiment is a modification of the crops management system shown in the first embodiment. Descriptions of configurations similar to those in the first embodiment will be omitted.

As shown in FIG. 7, the roll baler 20 includes an RFID tag 30, that is, an RFID reader (a wireless tag reader) 70 capable of receiving the identifying information of a wireless tag. For convenience of explanation, the RFID reader 70 provided in the roll baler 20 is referred to as a mounted reader. Like the RFID reader 50 of the first embodiment, the mounted reader 70 includes a reading part 51. The configuration of the reading part 51 is the same as that of the first embodiment, so its description is omitted.

The mounted leader 70 is provided in the vicinity of the discharge portion 28 or the discharge portion 28 for discharging the forming material K formed by the forming portion 27. Specifically, the discharge portion 28 is formed of a rectangular cover or the like that is openable and closable with respect to the housing portion 26, and is provided on the rear surface, the side surface, or the like of the cover. The reading part 51 of the mounted reader 70 is oriented inward of the cover and can detect the tag identifying information attached to the roll forming material K as described later.

The mounted reader 70 is connected to the communication device 11. Every time the roll forming material K is discharged from the discharging unit 28, the reading part 51 of the mounted leader 70 reads the information of the RFID tag 30 attached to the roll forming material K and transmits the read tag identifying information to the communication device 11. Upon receiving the tag identifying information, the communication device 11 outputs the tag identifying information to the server 40 or the like.

In addition, the communication device 11 transmits the forming material information to the server 40. In the mounted reader 70, the same function as that of the communication device 11 may be provided so that the tag reader 70 transmits the tag identifying information directly to the server 40.

There are various methods for attaching the RFID tag 30 of the roll forming material K. For example, the RFID tag 30 is attached to the packing material 29 for packing the roll forming material K in advance, and the packaging material 29 is wound by the winding mechanism, whereby the RFID tag 30 is attached to the roll forming material K.

Alternatively, a pasting machine may be provided for affixing the RFID tag 30 to the roll forming material K to the forming apparatus 23 of the roll baler 20, and when the packing material 29 is wound around the roll forming material K by the winding mechanism, the pasting machine may attach the RFID tag 30 to the material 29. The attachment of the RFID tag 30 to the roll forming material K is not limited to this, and other methods may be employed.

The server 40 receives the tag identifying information transmitted from the communication device 11 or the mounted reader 70. In addition, the server 40 receives the forming material information transmitted from the communication device 11. The relating part 43 and the second storage part 44 of the server 40 are the same as those in the first embodiment.

According to the crops management system of the second embodiment, every time the roll forming material K is discharged from the roll baler 20, the mounted leader 70 can automatically acquire the tag identifying information attached to the roll forming material K, the acquisition of the tag identifying information attached to the roll forming material K can be automated.

When transmitting the tag identifying information from the communication device 11 or the mounted reader 70 to the server 40, the user information is registered in the communication device 11 or the mounted reader 70 in advance, and the communication device 11 or the mounted reader 70 together with the tag identifying information may be transmitted to the server 40.

In addition, in the above-described embodiment, the forming material information and the tag identifying information are transmitted from the communication device 11 or the mounting reader 70 provided in the roll baler 20 directly to the server 40. However, instead of this, the forming material information and the tag identifying information may be transmitted to the server 40 via the operator computer 60.

In the case of going through the operator computer 60, it is not necessary to register the user information in the communication device 11 and the mounted reader 70, and the user is registered in the operator computer 60 and the operator computer 60 sends the user's information to the server 40 when transmitting the forming material information and the tag identifying information may be transmitted, the user information being registered in the operator computer 60.

In the above description, the embodiment of the present invention has been explained. However, all the features of the embodiment disclosed in this application should be considered just as examples, and the embodiment does not restrict the present invention accordingly. A scope of the present invention is shown not in the above-described embodiment but in claims, and is intended to include all modifications within and equivalent to a scope of the claims.

The information output device 10 may be a detection device that measures and outputs protein of the forming material K as a device that outputs forming material information, or a detection device that measures and outputs vitamins of the forming material K, or may be a detection device that measures and outputs the starch value of the forming material K or a detection device that measures and outputs the fiber quality of the forming material K.

In addition, in the above-described embodiment, the identifying information of the RFID tag 30 and the forming material information are associated, but in addition to this, the position of the work and the forming material information may be associated with each other. For example, a position detecting device for detecting a position based on a signal of a positioning satellite such as GPS may be provided in any one of the forming machine 20, the RFID reader 50, and the operator computer 60, and the position detected by the position detecting device and the formed material information may be related to each other.

In addition, it is also possible to previously input the grass type (the crops type) to the forming machine 20, the management device 40, the RFID reader 50, the operator computer 60, and the like, and the crops type may be associated with the forming material information.

What is claimed is:

1. A crops management system comprising:
an information outputting device disposed on a forming machine configured to form crops into a formed material having a predetermined shape and configured to output formed material information relating to the formed material;
a wireless tag disposed on the formed material and configured to store indentifying information of the formed material; and
a management device having:
an obtaining part configured to obtain the identifying information of the formed material and the formed material information of the formed material; and
a relating part configured to relate the formed material information to the identifying information obtained by the obtaining part.

2. The crops management system according to claim 1,
wherein the information outputting device has a weight detection device configured to detect a weight of the formed material and to output the weight as the formed material information,
wherein the obtaining part obtains the weight detected by the weight detection device,
and wherein the relating part relates the identifying information to the weight.

3. The crops management information according to claim 1,
wherein the information outputting device has a moisture detection device configured to detect moisture of formed material and to output the moisture as the formed material information,
wherein the obtaining part is configured to obtain the moisture detected by the moisture detection device,
and wherein the relating part relates the identifying information to the moisture.

4. The crops management information according to claim 1,
wherein the information outputting device has a time-counting device configured to output, as the formed material information, time spent in forming the formed material by the forming machine,
wherein the obtaining part obtains the time counted by the time-counting device,
and wherein the relating part relates the identifying information to the time.

5. The crops management system according to claim 1, comprising
a wireless tag reader having:
a reading part configured to read the identifying information stored in the wireless tag; and
an outputting part configured to output, to the management device, the identifying information read by the reading part.

6. The crops management system according to claim 5,
wherein the wireless tag reader has:
a requesting part configured to request, to the management device, the formed material information related to the identifying information read by the reading part; and
a displaying part configured to display the formed material information obtained based on the request of the requesting part.

7. The crops management system according to claim 1,
wherein the forming machine is a forming machine configured to form the formed materials having a rolled shape.
